(19) United States
(12) Patent Application Publication
(10) Pub. No.: US 2013/0138496 A1
(43) Pub. Date: May 30, 2013

(54) SYSTEMS, DEVICES AND METHODS FOR OFFLINE COUPON VERIFICATION

(71) Applicants: Jianming JIN, Beijing (CN); Bo WU, Santa Clara, CA (US); Lixin XU, Beijing (CN); Yuhong XIONG, Mountain View, CA (US)

(72) Inventors: Jianming JIN, Beijing (CN); Bo WU, Santa Clara, CA (US); Lixin XU, Beijing (CN); Yuhong XIONG, Mountain View, CA (US)

(73) Assignee: LaShou Group Inc.

(21) Appl. No.: 13/327,207

(22) Filed: Dec. 15, 2011

(30) Foreign Application Priority Data
Nov. 24, 2011 (CN) 201110378070.7

(51) Int. Cl. G06Q 30/02

(52) U.S. Cl. 705/14.26

(57) ABSTRACT

Computer-implemented methods, systems and devices facilitating the methods, and computer-readable medium storing computer readable code, which, when executed, performs the methods are provided for offline coupon verification. The methods may include inputting a verification code of a coupon to a coupon verification terminal, decrypting the verification code using a terminal private key to obtain a merchant ciphertext, decrypting the merchant ciphertext using a merchant-specific server public key to obtain a purchase information corresponding to the coupon, comparing the purchase information with a database to determine whether the purchase information is correct, displaying a negative verification result if the purchase information is not correct, and displaying a positive verification result if the purchase information is correct and the coupon has not been previously consumed, registering the coupon as consumed in the database for future verifications, when or after the coupon been verified, and synchronizing the database with that of a server.

### CROSS-REFERENCE TO RELATED PATENT APPLICATIONS

China P.R. Priority Application 201110378070.7, filed Nov. 24, 2011 including the specification, drawings, claims and abstract, is incorporated herein by reference in its entirety.

### FIELD OF DISCLOSURE

The present disclosure relates generally to systems, devices and methods for verifying certificates, vouchers or coupons for goods or services, and more particularly for verifying coupons offline to redeem the goods and services purchased through an internet commerce platform.

### BACKGROUND

With the rapid development of internet commerce, verification of certificates, vouchers or coupons for goods or services (referred to hereafter as “coupon” or “coupons” in general) has become a critical daily work of merchants and on-line commerce platform providers.

Conventional coupon verification methods include verifications via telephone or computer. For example, merchants may provide a verification code of the coupons received from customers by calling a verification hotline, the receiver of which then transmits the information received via telephone to a verification server. The verification server verifies the code and notifies the verification result to the merchants via the hotline by playing previously recorded voice messages. Specifically, the merchant's telephone number is saved in the telephone verification system so that when the merchant calls the hotline, the server may identify the particular merchant by the phone number. Once the server verifies the merchant's identity by a valid phone number thereof, the merchant can then enter the coupon verification code via the hotline. The server may then verify the validity of the coupon by the coupon verification code. If the coupon is deemed valid by the server, the customer can then redeem the goods or services purchased online from the merchant using the valid coupon. Such a telephone verification is not efficient, as many errors may occur during the complicated process, especially when the merchant has to operate in a noisy environment.

Another conventional method involves computer verification terminal that is connected to the internet. The merchant can use a pre-installed software or use an internet browser to communicate with the verification server via internet. The merchant enter to the internet browser the coupon verification code, which is then verified by the verification server. The result can then be displayed on the merchant's computer. Specifically, the merchant logs in to a website, where the merchant can access to an interface to enter coupon verification codes and submit requests for verifying the validity of the coupon codes by the server. Such a computer verification method requires at least a computer and internet access, and is thus not applicable in a variety of outdoor and/or non-fixed location scenarios.

In view of the above-explained problems of the conventional coupon verification methods, the instant application is directed to improve the coupon verification technology.

### SUMMARY

According to one embodiment, an offline coupon verification method is provided including inputting a verification code of a coupon to a coupon verification terminal, decrypting the verification code using a terminal private key to obtain a merchant ciphertext, decrypting the merchant ciphertext using a merchant-specific server public key to obtain a purchase information corresponding to the coupon, comparing the purchase information with a database to determine whether the purchase information is correct, displaying a negative verification result if the purchase information is not correct, and displaying a positive verification result if the purchase information is correct and the coupon has not been previously consumed, registering the coupon as consumed in the database for future verifications, when or after the coupon been verified, and synchronizing the database with that of a server.

According to another embodiment, a coupon verification terminal is provided including an input module configured to input a verification code of a coupon to the coupon verification terminal, a first decrypting module configured to decrypt the verification code using a terminal private key to obtain a merchant ciphertext, a second decrypting module configured to decrypt the merchant ciphertext using a merchant-specific server public key to obtain a purchase information corresponding to the coupon, a data storage module configured to store a database comprises information comprising online purchase, coupon verification and/or coupon consumption records, a purchase information comparison module configured to compare the purchase information with the database to determine whether the purchase information is correct, a displaying module configured to display a negative verification result if the purchase information is not correct, and to display a positive verification result if the purchase information is correct and the coupon has not been previously consumed, a registration module configured to register the coupon as consumed in the database for future verifications, when or after the coupon been verified, and a communication module configured to synchronize the database, via a wired or wireless network, with that of a server.

According to another embodiment, a coupon verification hub is provided including an information receiving module configured to receiving verification codes of coupons from two or more coupon verification terminals, via a local wired or wireless network, a first decrypting module configured to decrypt each of the verification codes using a terminal private key to obtain merchant ciphertexts, a second decrypting module configured to decrypt the merchant ciphertexts using a merchant-specific server public key to obtain purchase information the coupons, a data storage module configured to store a database comprises information comprising online purchase, coupon verification and/or coupon consumption records, a purchase information comparison module configured to compare the purchase information with the database to determine whether the purchase information is correct, a result sending module configured to send to the two or more coupon verification terminals verification results, a registration module configured to register the coupons as consumed in the database for future verifications, when or after the coupons been verified, and a communication module configured to synchronize the database, via a wired or wireless network, with that of a server.

According to another embodiment, a non-transitory computer-readable medium is provided including storing computer readable code, which, when executed, performs the method described above.

These and other embodiments and advantages thereof will become more readily apparent from the attached drawings and the detailed description that follow.

### BRIEF DESCRIPTION OF THE DRAWINGS

The preferred embodiments of the invention will be described in conjunction with the appended drawings provided to illustrate and not to the limit the invention, where like designations denote like elements, and in which:

FIG. 1 illustrates a flow chart according to a non-limiting example of the present invention.

FIG. 2 illustrates an exemplary coupon verification terminal according to one embodiment of the present invention.

FIG. 3 illustrates a schematic drawing of a coupon verification terminal in a non-limiting example.

FIG. 4 illustrates an exemplary system according to one embodiment of the present invention.

FIG. 5 illustrates an exemplary system according to another embodiment of the present invention.

### DETAILED DESCRIPTION

Following below are more detailed descriptions of various concepts related to, and embodiments of the above-described methods, systems and non-transitory computer-readable medium for implementing the methods. It should be appreciated that various concepts introduced above and discussed in greater detail below may be implemented in any of numerous ways, as the disclosed concepts are not limited to any particular manner of implementation. Examples of specific implementations and applications are provided primarily for illustrative purposes.

According to one embodiment, an offline coupon verification method is provided including inputting a verification code of a coupon to a coupon verification terminal, decrypting the verification code using a terminal private key to obtain a merchant ciphertext, decrypting the merchant ciphertext using a merchant-specific server public key to obtain a purchase information corresponding to the coupon, comparing the purchase information with a database to determine whether the purchase information is correct, displaying a verification result, registering the coupon as consumed in the database for future verifications, when or after the coupon been verified, and synchronizing the database with that of a server.

A positive verification result is displayed if the purchase information is correct and the coupon has not yet been consumed (i.e., redeemed). A negative verification result is displayed if the purchase information is incorrect or if the coupon has previous been consumed. If a negative verification result is returned because the coupon has been consumed, the coupon verification terminal may display when and/or where the coupon was redeemed.

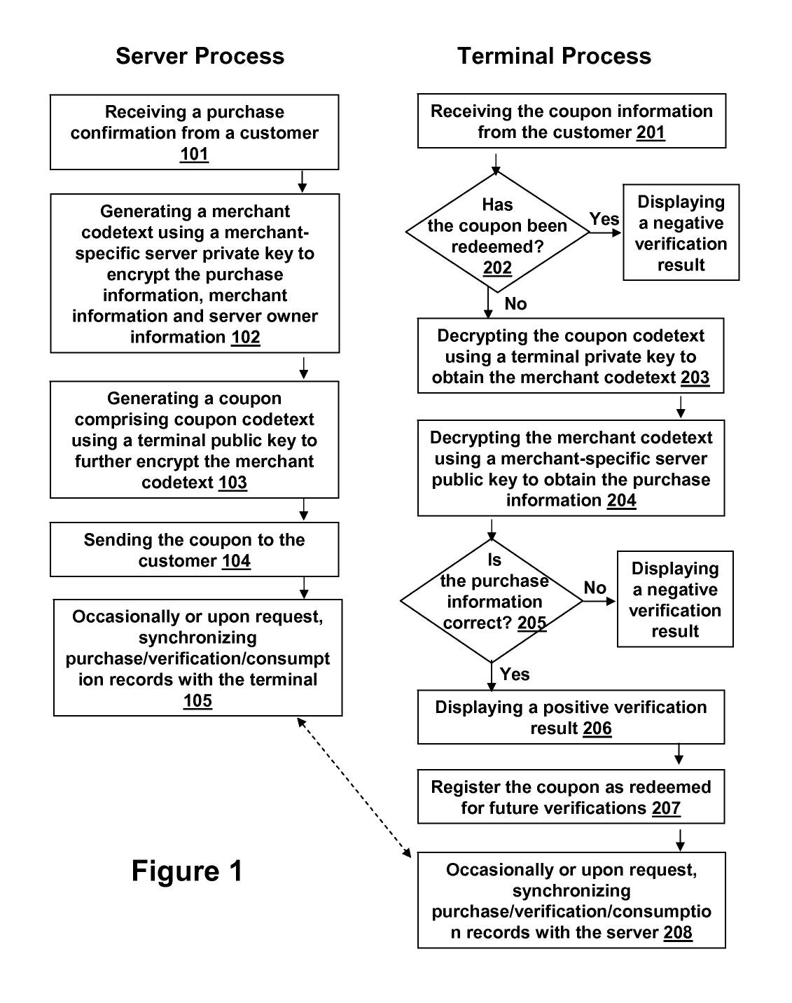

FIG. 1 illustrates a flow chart according to a non-limiting example of the above-described coupon verification method. In the following description, a group buying website is used as an illustrative example. Other internet commerce sites may also use similar methods that allow participating merchants to verify coupon issued by the internet commerce sites.

In some embodiments, the verification code of a coupon is issued by an internet commerce platform, for example but not limited to an internet group buying platform. In some embodiments, the verification code of the coupon is issued by a sever when or after a purchase is confirmed by a customer at step 101, by generating a merchant ciphertext using a merchant-specific server private key to encrypt the purchase information and sever owner information, at step 102, followed by further encrypting the merchant ciphertext using a terminal public key, at step 103. The coupon can then be sent to the customer at step 104. The coupon verification code may be sent to the customer by any suitable methods/media, for example but not limited to email, fax, voice message, short text message, multimedia message, or near field communication (NFC), etc.

The merchant-specific server private key and the merchant-specific server public key are a pair of merchant specific keys generated by the server, while the terminal private key and the terminal public key are a pair of terminal specific keys generated by the server. The merchant-specific server public key and the terminal private key are saved in the coupon verification terminal, and the merchant-specific server private key and the terminal public key are saved in the server.

At step 105, the server may synchronize its database comprising online purchase, coupon verification and coupon consumption information that are relevant to the corresponding merchant with the coupon verification terminal. In some embodiments, the server may be configured to synchronize its database with that of the coupon verification terminal every time when the coupon verification terminal is connected to the internet or a mobile network. Alternatively, the server may only synchronize its database with that of the coupon verification terminal upon request, or periodically at a previously determined frequency. In some other embodiments, the server may only synchronize its database with that of the coupon verification terminal occasionally when some previously set conditions are met.

The customer can then redeem for the goods/services purchased from the merchant using the coupon received. To verify the coupon provided by the customer, the merchant can input the coupon information, for example but not limited to a coupon serial number and a password of the coupon, etc., to the coupon verification terminal, at step 201. The coupon information may be entered to the coupon verification terminal by any suitable methods, for example but not limited to via at least one of keyboard, bar code scanner, voice input device, or near field communication device.

In some embodiments, the verification code is firstly compared with the database, at step 202 to determine whether the coupon has been previously consumed. If it has been previously consumed, the process will be terminated and a negative verification result will be displayed.

If the coupon has not yet be consumed, the coupon verification terminal will then decrypt the verification code using the terminal private key to obtain the merchant ciphertext, at step 203, followed by decrypting the merchant ciphertext using a merchant-specific server public key to obtain a purchase information corresponding to the coupon, at step 204.

Next, the terminal will compare the purchase information with its database to determine whether the purchase information is correct, at step 205. If the coupon information is found incorrect, the process will be terminated and a negative verification result will be displayed. If the coupon information is found correct, a positive verification result will be displayed at step 206. The verification results may be displayed by an LCD display module of the verification terminal to the merchant and/or the customer. Negative verification results may provide to the merchant/customer extra information, for example causing a display showing that: (1) the coupon is invalid, cannot be used to redeem the goods/services; (2) the coupon expired and when; (3) the coupon has been previously redeemed and when; (4) the coupon can not be used for other reasons and why (e.g., the coupon is suspended or a request for refund is pending, etc.). Similarly, a positive verification result may provide extra information such as name of the goods/services purchased and price, etc.

In some embodiments, the terminal may then register the coupon as consumed in the database for future verifications, at step 207, when or after the coupon been verified.

At step 208, the terminal may synchronize its database comprising online purchase, coupon verification and/or coupon consumption information with that of the coupon verification terminal. The synchronization may happen every time when the coupon verification terminal is connected to the internet or a mobile network. Alternatively, it may only happen upon request, or periodically at a previously determined frequency. The synchronization may also be performed occasionally when some previously set conditions are met. Any suitable network, for example but not limited to internet, wide-area network (WAN), or local-area network (LAN), and mobile networks such as GPRS network, WCDMA network, TD-SCDMA network or CDMA2000 network, may be used for the communication.

In some embodiments, two or more coupon verification terminals may communicate directly with each other to synchronize databases thereof via a local wired or wireless network. In some other embodiments, the two or more coupon verification terminals may synchronize their databases, via a local wired or wireless network, with a local hub, which can then synchronizes with the server.

In some embodiments, when the coupon verification terminal and the server can communicate in substantially real time via a wireless or wired network, an online verification mode that is described in a co-pending application Ser. No. 13/327,117, which is hereby incorporated by reference in its entirety, rather than the off-line verification mode described above, may be used to facilitate the coupon verification.

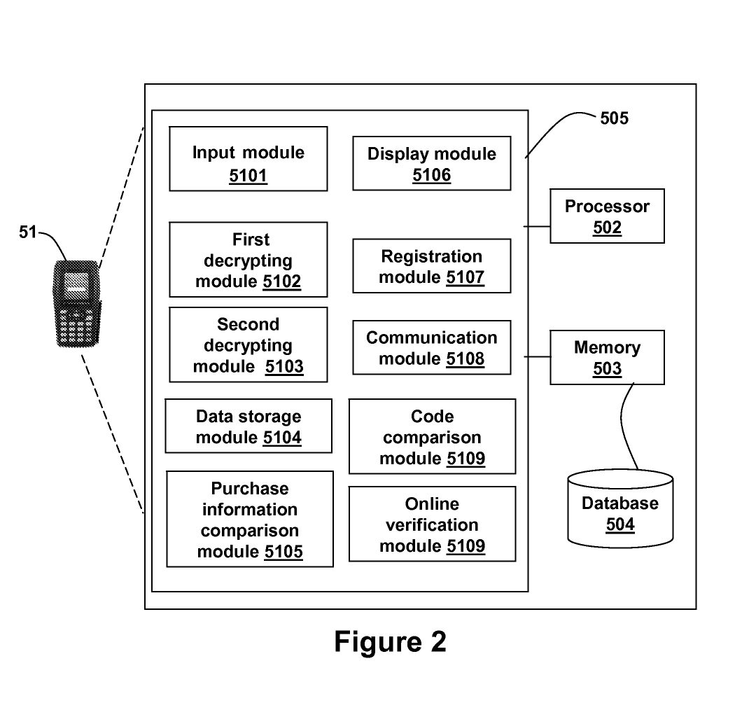

In some embodiments, as illustrated in FIG. 2, the coupon verification terminal 51 may comprise a processor 502, a memory device 503 that connects to a database 504, and the coupon verification terminal management module 505.

The coupon verification terminal management module 505 may comprise an input module 5101, a first decrypting module 5102, a second decrypting module 5103, a data storage module 5104, a purchase information comparison module 5105, a displaying module 5106, a registration module 5107, and a communication module 5108.

The input module 5101 is configured to input a verification code of a coupon to the coupon verification terminal. In some embodiments, the inputting module comprises at least one of keyboard, bar code scanner, voice input device, or near field communication device.

The first decrypting module 5102 is configured to decrypt the verification code using a terminal private key to obtain a merchant ciphertext. The second decrypting module 5103 is configured to decrypt the merchant ciphertext using a merchant-specific server public key to obtain a purchase information corresponding to the coupon.

The data storage module 5104 is configured to store a database comprises information comprising online purchase, coupon verification and/or coupon consumption records. In some embodiments, the data storage module 5104 also saves the merchant-specific server public key and the terminal private key, while the merchant-specific server private key and the terminal public key are saved in the server.

The purchase information comparison module 5105 is configured to compare the purchase information with the database 504 to determine whether the purchase information is correct. In some embodiments, the purchase information includes but not limited to price of goods/services purchased, quantity of the goods/services purchased, name of the merchant, name of the online commerce website, and payment method, etc.

The displaying module 5106 is configured to display a negative verification result if the purchase information is not correct, and to display a positive verification result if the purchase information is correct and the coupon has not been previously consumed. In some embodiments, the coupon verification terminal may be configured to print the verification result.

The registration module 5107 is configured to register the coupon as consumed in the database 504 for future verifications, when or after the coupon been verified.

The communication module 5108 is configured to synchronize the database 504, via a wired or wireless network, with that of a server. The step of synchronizing the database 504 with that of the server comprises uploading to the server and downloading from the server information comprising online purchase, coupon verification and/or coupon consumption. The synchronization may happen every time when the coupon verification terminal is connected to the internet or a mobile network. Alternatively, it may only happen upon request, or periodically at a previously determined frequency. The synchronization may also be performed occasionally when some previously set conditions are met. In some embodiments, the communication module is configure to allow the coupon verification terminal communicate directly with at least one other coupon verification terminal to synchronize databases thereof via a local wired or wireless network. In some other embodiments, the communication module is configure to allow the coupon verification terminal synchronize the database, via a local wired or wireless network, with a local hub, which is connected to at least one other coupon verification terminal via the local wired or wireless network.

In some embodiments, the terminal 51 may further comprise a code comparison module 5109 that is configured to compare the verification code with the database 504 to determine whether the coupon has been previously consumed. Such a step may be performed prior to the step of decrypting the verification code. If the coupon has been previously redeemed, the process can be terminated.

Furthermore, the terminal 51 may optionally comprise an online verification module 5110, which allows the merchant to choose to verify the coupon online by the server real-timely, rather than the offline process described above, if the coupon verification terminal and the server can real-timely communicate via a wireless or wired network. Any suitable online verification may be used, for example the online verification methods and functions described in the co-pending application Ser. No. 13/327,117, which is hereby incorporated by reference in its entirety, may be a desired option. The terminal 51 may be set as automatically switch from an off-line verification mode to an on-line verification mode, or allows the user to choose between the two modes, when a real-time connection between the terminal and the server is available.

The different modules within the coupon verification management module 45 are function modules that interwork with each other. The function modules, when executed by processor 502, allow the system to effectively and efficiently manage the above-described coupon verification processes. One or more of the function modules may be omitted, and additional modules may be added if needed.

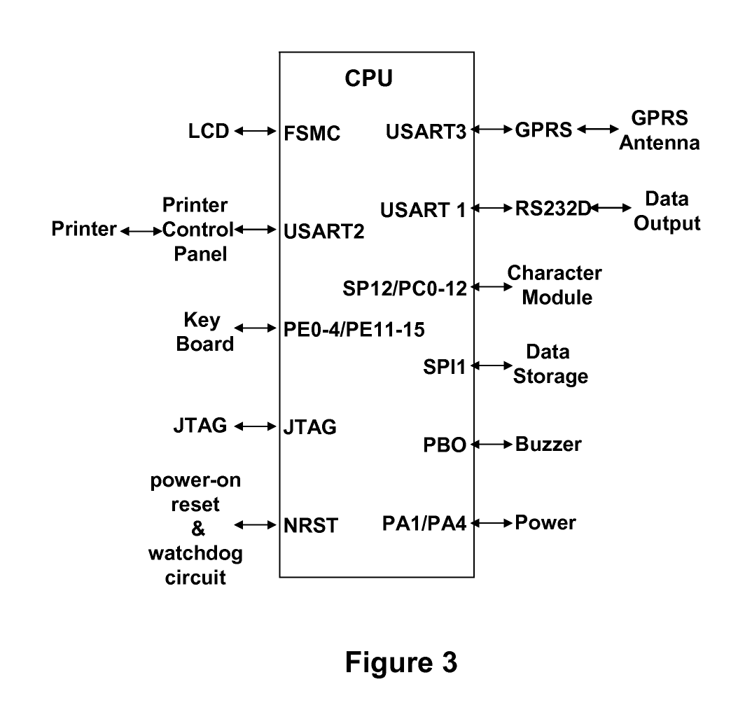

FIG. 3 shows a schematic drawing of a coupon verification terminal in a first non-limiting example. In this non-limiting example, the coupon verification terminal comprises a mother board, on which a CPU and its external circuit, a data storage module, and a character module. The mother board may also comprise ports for connecting the CPU to a display module, a print module, a mobile communication module, a data export, a SIM card, a battery, an input module, a joint test action group (JTAG), and a buzzer. In this non-limiting example, GPRS module are used for the mobile communication. Of course, any other suitable mobile networks, such as WCDMA network, TD-SCDMA network or CDMA 2000 network, may be used.

In this non-limiting example, the CPU is a STM32F103VCT6 having a core of ARM 32-bit Cortex™ M3, which has an up to 72 MHz frequency and has a built-in 256K flash memory and 48 k SRAM. The STM32F103VCT6 chip can have a built-in power-on reset and watchdog circuit. In this example, the chip reserves an external power-on reset and watchdog circuit, where a IMP706TESA chip may be used. For using the built-in circuit, a 0.01 μF capacitor needs to be connected to the NRST pin of the CPU to shield the external reset chip.

The CPU has a FSMC module that can be connected to a LCD display, and a real-time clock circuit that can be connected to a crystal and a battery or other power supply. It also has 5 USAPT ports, one of which can be used for burning programs and upgrades. In addition, the 2 SPI ports can be used for connecting the storage devices with the CPU.

The terminal may also has a multi-channel AD control circuit that can be used for analog data acquisition and monitoring, a multiple GPIO, and a variety of power-saving mode.

In this non-limiting example, the terminal is supplied by a 12V/1.5 A power adapter, using a 7.4V rechargeable lithium-ion battery pack as a backup power source when there is no electricity available. The power supply can be seamlessly switched to battery simply by removing the power adapter. When operating on battery power, the user can optionally choose whether or not to use a power saving mode to extend the battery run time. The power adapter can function correctly regardless whether the battery is assembled in the terminal or not.

In some embodiments, the terminal may have a hard power switch. Alternatively, the terminal may have no hard power switch, while a soft power switch may be included on a keyboard of the input module. When it is turned off, the CPU will turn off all peripheral power supply, and enter a sleep mode. In the sleep mode, only the CPU itself consumes power, lowering the current to about 10 mA or smaller.

The data storage module used in this example is W25Q16 having an SPI interface and a storage capacity of 2M bytes. The storage capacity can be changed to smaller or greater if desired.

In this non-limiting example, a GT23L24T3Y module having a SPI port is used for the character module. The GT23L24T3Y module has three sets of fonts including GB2312, GB12345 and BIG5, as well as three built-in matrix including a 11×12 matrix, a 15×16 matrix and a 24×24 matrix.

The UART port of the RS232 level converter chip can be used as the data export port, connecting to the USART port of the CPU. This UART port can also be used of burning programs to the CPU. When burning programs via the USART1 port, Boot 1 and Boot 0 shall be set to 01, while in operating mode Boot 1 and Boot 0 are set to 00.

In this example, a surface mount passive buzzer is used as the buzzer interface circuit, to provide a buzzer small enough to fit the small space limited by the size of terminal.

A printer control panel is included in this example as a relatively independent unit, which has a separate CPU, character module and a printer driver module. In this example, a STM32F101RBT6 CPU having a frequency up to 36 MHz, with a 10K bytes built-in RAM, 64K byte Flash memory, is used for the printer control panel CPU. The printer control panel can communicate with the CPU on the mother board of the terminal. The character module of the printer control panel may be the same as that of the mother board. The programs can be burned via the JTAG port.

The above-described example of a coupon verification terminal may be configured to facilitate methods and functions for on-line and off-line coupon verifications.

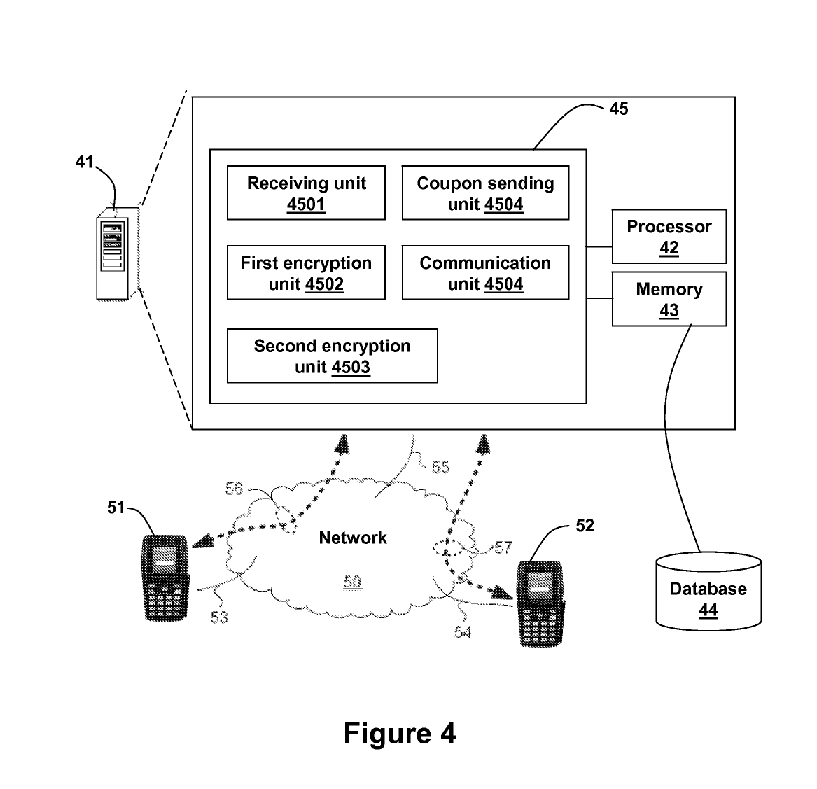

FIG. 4 illustrates an example system according to one embodiment of the present invention. Such an illustrative example of the system may comprise a server 41, a plurality of coupon verification terminals such as a first coupon verification terminal 51, a second coupon verification terminal 52, and a network 50 that interconnects the server 41 and the plurality of coupon verification terminals via wired or wireless communication links 53-55. The system may be used at the merchant sites to verify coupon issued to consumers of goods and/or service via an internet commerce platform, for example but not limited to a group buying website. For example, the merchants may utilize coupon verification terminals to verify coupon codes provided by the consumers to determine whether or not the consumer may redeem the coupon he posses for corresponding goods and/or services, and synchronize its database with that of the server occasionally, periodically, or upon request. Any desired devices, such as cell phone, PDA, computer and other electronic devices that is capable of processing the coupon verification data and allow transmission of the related data to and from the server 41 via a mobile network may be used as the coupon verification terminals. Any suitable network, for example but not limited to internet, wide-area network (WAN), or local-area network (LAN), and mobile networks such as GPRS network, WCDMA network, TD-SCDMA network or CDMA2000 network, may be used.

The server 41 comprises a processor 42, a memory device 43 that connects to a permanent database 44, and a coupon verification management module 45. The coupon verification management module 45 comprises a receiving unit 4501, a first encryption unit 4502, a second encryption unit 4503, a coupon sending unit 4504, and a communication unit 4505.

The receiving unit 4501 is configured to receive a purchase confirmation from a customer. The first encryption unit 4502 can then generate a merchant ciphertext using a merchant-specific server private key to encrypt information including the purchase information, merchant information, sever owner information and/or other relevant information. The merchant ciphertext may then be encrypted by the second encryption unit 4503, using a terminal public key, to issue a coupon.

The coupon sending unit 4504 can then send the coupon generated to the customer via methods including but not limited to email, fax, voice message, short text message, multimedia message, or near field communication (NFC).

The communication unit 4505 is configured to synchronize the portion of its database 44 that is relevant to corresponding coupon verification terminals, via a wired or wireless network, with the databases of the coupon verification terminals.

In some embodiments, the server 41 further comprises other units for online verification applications described in the co-pending application Ser. No. 13/327,117, which is hereby incorporated by reference in its entirety.

The different modules within the coupon verification management module 45 are function modules that interwork with each other. The function modules, when executed by processor 42, allow the system to effectively and efficiently manage the above-described coupon verification processes. One or more of the function modules may be omitted, and additional modules may be added if needed. Communication messages (e.g., 56 and 57) may be exchanged between the server 41 and coupon verification terminals 51-52, etc., via the mobile network 50.

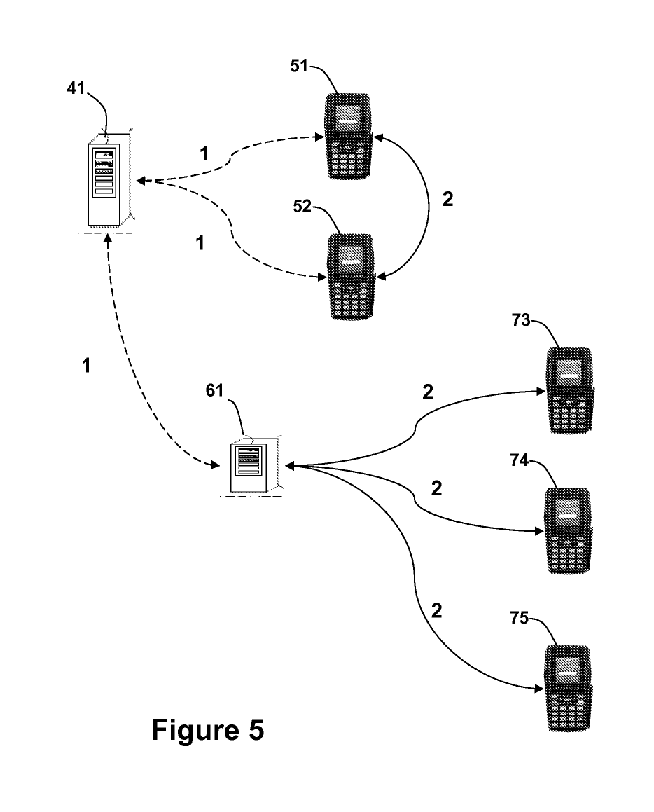

In some other embodiments, as shown in FIG. 5, two or more of the coupon verification terminals (e.g., 51 and 52), in addition to synchronizing their databases with the server 1 via a network 1, may communicate directly to synchronize databases thereof via a local wired or wireless network 2. Alternatively or additionally, the two or more of the coupon verification terminals (e.g., 73, 74, 75) may synchronize their databases, via a local wired or wireless network 2, with a local hub 61, respectively. The coupon verification hub 61 can then synchronize its database with the server 41, via a network 1.

In some embodiments, the coupon verification hub 61 may process the coupon verification functions described above, while the two or more coupon verification terminals simply perform the coupon information inputting, and verification result displaying functions. In these embodiments, the coupon verification hub 61 may comprise an information receiving module configured to receiving a verification code of a coupon from two or more coupon verification terminals (e.g., 73, 74, 75), via a local wired or wireless network 2, a first decrypting module configured to decrypt the verification code using a terminal private key to obtain a merchant ciphertext, a second decrypting module configured to decrypt the merchant ciphertext using a merchant-specific server public key to obtain a purchase information corresponding to the coupon, a data storage module configured to store a database comprises information comprising online purchase, coupon verification and coupon consumption records, a purchase information comparison module configured to compare the purchase information with the database to determine whether the purchase information is correct, a result sending module configured to send to the two or more coupon verification terminals a verification result, a registration module configured to register the coupon as consumed in the database for future verifications, when or after the coupon been verified, and a communication module configured to synchronize the database, via a wired or wireless network, with that of a server.

Compared to the conventional telephone or computer verification methods, the above-described methods have many advantages. For example, using the verification terminal and the system described above, the verification process of a coupon can be less than 3 seconds, which is almost impossible if the conventional methods are used. Second, the verification process is much more reliable. The terminal can save records of the verification history, providing another source of data for possible auditing if desired. In contrast, if the conventional methods are used, the verification history would be only available at the server. Third, it is more convenient for the merchant to use, without requiring the complicated voice direction and password entering in the telephone verification or computer and internet knowledge in using the computer verification method. Finally, the above described off-line verification method only requires an internet or mobile network access occasionally, and therefore can be used in remote area conveniently.

The functions and modules described above may be implemented in hardware, software, firmware, or any combinations thereof. If implemented in software, the functions may be stored on or transmitted over as one or more instructions or code on a computer readable (processor-readable) medium. Computer-readable media include both computer storage media and communication media including any medium that facilitates transfer of a computer program from one place to another. A storage media may be any available media that can be accessed by a computer or similar devices. By way of example, and not limitation, such computer-readable media can comprise RAM, ROM, EEPROM, CDROM or other optical disk storage, magnetic disk storage or other magnetic storage devices, or any other medium that both can be used to carry or store desired program code in the form of instructions or data structures, and can be accessed by a computer or similar devices. In addition, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies are included in the definition of medium. Disk and disc, as used herein, include compact disc (CD), laser disc, optical disc, digital versatile disc (DVD), floppy disk, and blue-ray disc where disks usually reproduce data magnetically, while discs reproduce data optically with lasers. Combinations of the above should also be included within the scope of computer-readable media.

The above-described embodiments and examples are to be considered in all respects only as illustrative and not restrictive, and the scope of the invention is, therefore, indicated by the appended claims rather than by the foregoing description. Those of skill in the art will recognize changes, substitutions and other modifications that will nonetheless come within the scope of the invention and range of the claims.

What is claimed is:

1. An offline coupon verification method, comprising:
inputting a verification code of a coupon to a coupon verification terminal,
decrypting the verification code using a terminal private key to obtain a merchant ciphertext;
decrypting the merchant ciphertext using a merchant-specific server public key to obtain a purchase information corresponding to the coupon;
comparing the purchase information with a database to determine whether the purchase information is correct;
displaying a negative verification result if the purchase information is not correct, and displaying a positive verification result if the purchase information is correct and the coupon has not been previously consumed;
registering the coupon as consumed in the database for future verifications, when or after the coupon been verified; and
synchronizing the database with that of a server.

2. The coupon verification method of claim 1, wherein the step of synchronizing the database with that of the server comprising upload to the server and download from the server information comprising online purchase, coupon verification and coupon consumption, periodically, or occasionally, or upon request.

3. The coupon verification method of claim 1, further comprising allowing an online verification of the coupon by the server when the coupon verification terminal and the server can real-timely communicate via a wireless or wired network.

4. The coupon verification method of claim 1, further comprising comparing the verification code with the database to determine whether the coupon has been previously consumed prior to the step of decrypting the verification code, and terminating the process if the coupon has been previously redeemed.

5. The coupon verification method of claim 1, wherein the verification code of the coupon is issued by a sever when or after a purchase is confirmed by a customer, by a method comprising:
generating a merchant ciphertext using a merchant-specific server private key to encrypt the purchase information and sever owner information; and
generating the verification code of the coupon using a terminal public key to further encrypt the merchant ciphertext.

6. The coupon verification method of claim 5, wherein:
the merchant-specific server private key and the merchant-specific server public key are a pair of merchant specific keys generated by the server,
the terminal private key and the terminal public key are a pair of terminal-specific keys generated by the server,
the merchant-specific server public key and the terminal private key are saved in the coupon verification terminal, and
the merchant-specific server private key and the terminal public key are saved in the server.

7. The coupon verification method of claim 1, wherein the coupon verification code comprises a coupon serial number and a password.

8. The coupon verification method of claim 1, wherein the coupon verification code is received by the customer from the server via at least one method of email, fax, voice message, short text message, multimedia message, or near field communication (NFC).

9. The coupon verification method of claim 1, wherein the step of inputting the coupon verification code to the coupon verification terminal comprises inputting the coupon verification code via at least one of keyboard, bar code scanner, or near field communication device.

10. The coupon verification method of claim 1, further comprising allowing the coupon verification terminal communicate directly with at least one other coupon verification terminal to synchronize databases thereof via a local wired or wireless network.

11. The coupon verification method of claim 1, further comprising allowing the coupon verification terminal synchronize the database, via a local wired or wireless network, with a local hub, which is connected to at least one other coupon verification terminal via the local wired or wireless network.

12. An coupon verification terminal, comprising:
an input module configured to input a verification code of a coupon to the coupon verification terminal;
a first decrypting module configured to decrypt the verification code using a terminal private key to obtain a merchant ciphertext;
a second decrypting module configured to decrypt the merchant ciphertext using a merchant-specific server public key to obtain a purchase information corresponding to the coupon;
a data storage module configured to store a database comprises information comprising online purchase, coupon verification and/or coupon consumption records;
a purchase information comparison module configured to compare the purchase information with the database to determine whether the purchase information is correct;
a displaying module configured to display a negative verification result if the purchase information is not correct, and to display a positive verification result if the purchase information is correct and the coupon has not been previously consumed;
a registration module configured to register the coupon as consumed in the database for future verifications, when or after the coupon been verified; and
a communication module configured to synchronize the database, via a wired or wireless network, with that of a server.

13. The coupon verification terminal of claim 12, wherein the step of synchronizing the database with that of the server comprising upload to the server and download from the server information comprising online purchase, coupon verification and coupon consumption, periodically, or occasionally, or upon request.

14. The coupon verification terminal of claim 12, further comprising an online verification module configured to allow an online verification of the coupon by the server when the coupon verification terminal and the server can real-timely communicate via a wireless or wired network.

15. The coupon verification terminal of claim 12, further comprising a code comparison module configured to compare the verification code with the database to determine whether the coupon has been previously consumed prior to the step of decrypting the verification code, and terminating the process if the coupon has been previously redeemed.

16. The coupon verification terminal of claim 12, wherein the verification code of the coupon is issued by a sever when or after a purchase is confirmed by a customer, by a method comprising:
generating a merchant ciphertext using a merchant-specific server private key to encrypt the purchase information and sever owner information; and
generating the verification code of the coupon using a terminal public key to further encrypt the merchant ciphertext.

17. The coupon verification terminal of claim 16, wherein:
the merchant-specific server private key and the merchant-specific server public key are a pair of merchant specific keys generated by the server,
the terminal private key and the terminal public key are a pair of terminal-specific keys generated by the server,
the merchant-specific server public key and the terminal private key are saved in the coupon verification terminal, and
the merchant-specific server private key and the terminal public key are saved in the server.

18. The coupon verification terminal of claim 12, wherein the coupon verification code comprises a coupon serial number and a password.

19. The coupon verification terminal of claim 12, wherein the coupon verification code is received by the customer from the server via at least one method of email, fax, voice message, short text message, multimedia message, or near field communication (NFC).

20. The coupon verification terminal of claim 12, wherein the inputting module comprises at least one of keyboard, bar code scanner, or near field communication device.

21. The coupon verification terminal of claim 12, wherein the communication module is configure to allow the coupon verification terminal communicate directly with at least one other coupon verification terminal to synchronize databases thereof via a local wired or wireless network.

22. The coupon verification terminal of claim 12, wherein the communication module is configure to allow the coupon verification terminal synchronize the database, via a local wired or wireless network, with a local hub, which is connected to at least one other coupon verification terminal via the local wired or wireless network.

23. An coupon verification hub, comprising:
an information receiving module configured to receiving verification codes of coupons from two or more coupon verification terminals, via a local wired or wireless network;
a first decrypting module configured to decrypt each of the verification codes using a terminal private key to obtain merchant ciphertexts;
a second decrypting module configured to decrypt the merchant ciphertexts using a merchant-specific server public key to obtain purchase information the coupons;
a data storage module configured to store a database comprises information comprising online purchase, coupon verification and/or coupon consumption records;
a purchase information comparison module configured to compare the purchase information with the database to determine whether the purchase information is correct;
a result sending module configured to send to the two or more coupon verification terminals verification results;
a registration module configured to register the coupons as consumed in the database for future verifications, when or after the coupons been verified; and
a communication module configured to synchronize the database, via a wired or wireless network, with that of a server.
